(19) United States
(12) Patent Application Publication
(10) Pub. No.: US 2023/0202018 A1
(43) Pub. Date: Jun. 29, 2023

(54) GEAR ASSEMBLY FOR A POWER TOOL

(71) Applicant: MILWAUKEE ELECTRIC TOOL CORPORATION, Brookfield, WI (US)

(72) Inventors: Kevin K. TAYLOR, Grafton, WI (US); Troy C. THORSON, Cedarburg, WI (US)

(21) Appl. No.: 17/047,846

(22) PCT Filed: Aug. 28, 2020
(86) PCT No.: PCT/US2020/048435

§ 371 Date: Oct. 15, 2020

Related U.S. Application Data
(60) Provisional application No. 62/893,369, filed on Aug. 29, 2019.

(51) Int. Cl. B25F 5/00; B25F 5/02; B25B 21/02

(52) U.S. Cl. CPC B25F 5/001; B25F 5/02; B25B 21/02

(57) ABSTRACT

A power tool includes a housing, a motor positioned within the housing, an output mechanism rotatably supported within the housing, and a gear assembly positioned within the housing. The output mechanism is configured to rotate about a longitudinal axis. The gear assembly is coupled between the motor and the output mechanism to transfer a torque generated by the motor to the output mechanism. The gear assembly includes a ring gear, a cylindrical interior bearing surface adjacent the ring gear, and a planet gear. The planet gear includes a planet gear portion configured to mesh with the ring gear to rotate the output mechanism about the longitudinal axis, and a planet bearing portion that defines a cylindrical outer bearing surface. The cylindrical outer bearing surface is configured to roll along the cylindrical interior bearing surface to radially support the output mechanism for rotation about the longitudinal axis.

### CROSS-REFERENCE TO RELATED APPLICATIONS

This application claims priority to U.S. Provisional Patent Application No. 62/893,369, filed Aug. 29, 2019, the entire content of which is hereby incorporated by reference.

### FIELD OF THE INVENTION

The present invention relates to power tools, and more particularly to impact

power tools.

### BACKGROUND OF THE INVENTION

Power tools such as impact drivers are capable of delivering rotational impacts to a workpiece at high speeds by storing energy in a rotating mass and transmitting it to an output shaft. Such impact drivers generally have a gear assembly for reducing a rotational speed between an input mechanism (e.g., a motor) and an output mechanism (e.g., a torque impact mechanism). Such impact drivers also generally include multiple bearings for rotatably supporting rotating components of the impact driver, such as the motor, the torque impact mechanism, etc.

### SUMMARY OF THE INVENTION

The present invention provides, in one aspect, a power tool including a housing, a motor positioned within the housing, an output mechanism rotatably supported within the housing, and a gear assembly positioned within the housing. The output mechanism is configured to rotate about a longitudinal axis. The gear assembly is coupled between the motor and the output mechanism to transfer a torque generated by the motor to the output mechanism. The gear assembly includes a ring gear, a cylindrical interior bearing surface adjacent the ring gear, and a planet gear. The planet gear includes a planet gear portion and a planet bearing portion that defines a cylindrical outer bearing surface. The planet gear portion is configured to mesh with the ring gear to rotate the output mechanism about the longitudinal axis. The cylindrical outer bearing surface is configured to roll along the cylindrical interior bearing surface to radially support the output mechanism for rotation about the longitudinal axis.

The present invention provides, in another aspect, a power tool including a housing, a motor positioned within the housing, an output mechanism rotatably supported within the housing, and a gear assembly positioned within the housing. The output mechanism is configured to rotate about a longitudinal axis. The gear assembly is coupled between the motor and the output mechanism to transfer a torque generated by the motor to the output mechanism. The gear assembly includes a ring gear and a planet gear carried by the output mechanism. The ring gear includes a ring gear portion and a ring bearing portion that defines a cylindrical interior bearing surface. The planet gear includes a planet gear portion and a planet bearing portion that defines a cylindrical outer bearing surface. The planet gear portion is configured to mesh with the ring gear portion to rotate the output mechanism about the longitudinal axis. The cylindrical outer bearing surface is configured to roll along the cylindrical interior bearing surface to radially support the output mechanism for rotation about the longitudinal axis.

The present invention provides, in another aspect, an impact driver including a main housing, a transmission housing coupled to the main housing, a motor positioned within the main housing, a torque impact mechanism rotatably supported within the transmission housing, and a gear assembly. The motor includes a pinion. The torque impact mechanism is configured to rotate about a longitudinal axis. The torque impact mechanism includes an output shaft and a drum configured to receive a continuous torque input from the motor. The gear assembly is coupled between the motor and the drum and configured to transmit the continuous torque input from the motor to the drum. The gear assembly includes a ring gear, a plurality of planet gears rotatably supported by the drum and meshed with the ring gear, and a cylindrical interior bearing surface adjacent the ring gear. Each planet gear includes a planet gear portion having a plurality of teeth meshed with corresponding teeth on the ring gear, and a cylindrical planet bearing portion extending from the planet gear portion. The cylindrical planet bearing portion is configured to roll along the cylindrical interior bearing surface to radially support the drum.

Other features and aspects of the invention will become apparent by consideration of the following detailed description and accompanying drawings.

### BRIEF DESCRIPTION OF THE DRAWINGS

FIG. 1 is a perspective view of a power tool, such as an impact driver.

FIG. 2 is a partially exploded perspective view of the impact driver of FIG. 1.

FIG. 3 is an exploded perspective view of portions of the impact driver of FIG. 1.

FIG. 4 is another exploded perspective view of portions of the impact driver of FIG. 1.

FIG. 5 is a cross-sectional view of the impact driver of FIG. 1, taken along line 5-5 of FIG. 1.

FIG. 6 is an enlarged cross-sectional view of the impact driver of FIG. 5.

FIG. 7 is a cross-sectional perspective view of portions of the impact driver of FIG. 1, taken along line 7-7 of FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

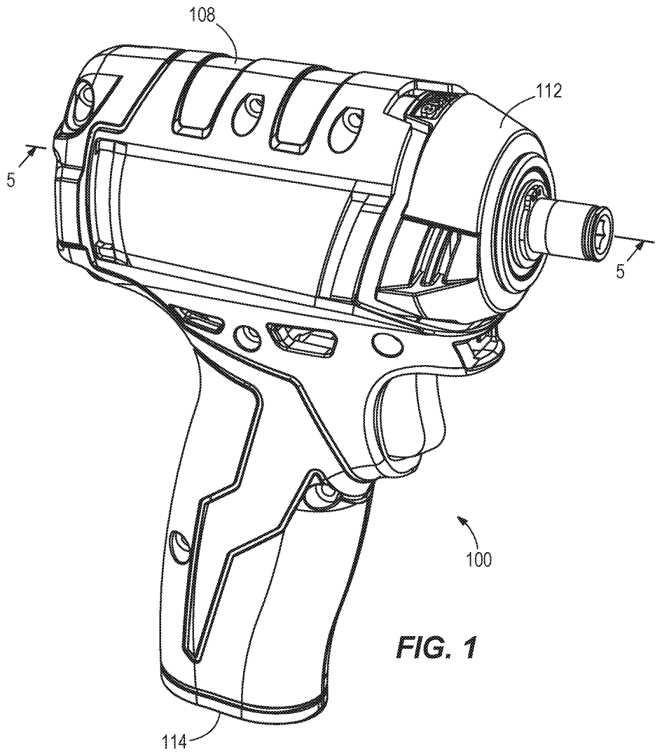

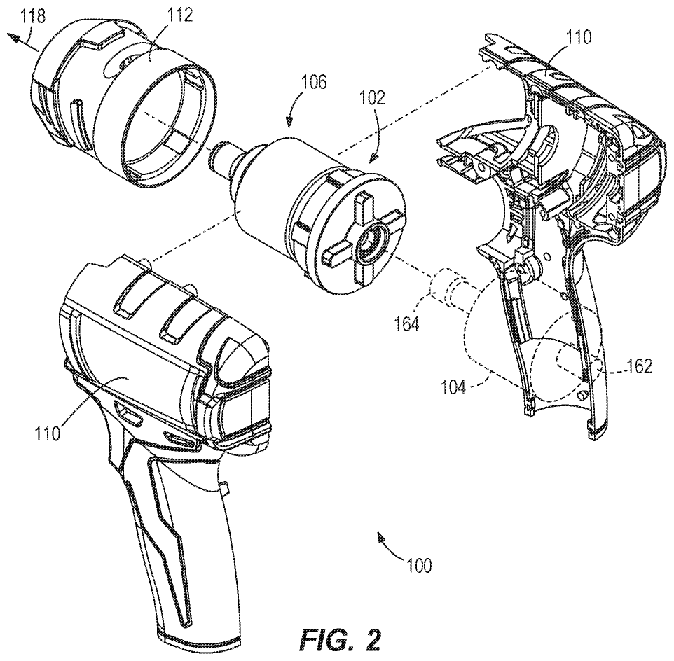

FIG. 1 illustrates a power tool 100, such as an impact driver 100. The impact driver 100 includes a planetary gear assembly 102 (FIG. 2) that transmits torque from a source or input mechanism 104 (e.g., an electric motor 104; FIG. 2) to an output mechanism 106 (e.g., a hydraulic torque impact mechanism 106; FIG. 2). Although the power tool 100 is shown and described herein as an impact driver 100, it should be noted that the planetary gear assembly 102 is equally applicable to other power tools (e.g., drills, saws, drivers, routers, etc.) that are operable to transfer torque between rotatable input and output components.

With reference to FIGS. 1 and 2, the illustrated impact driver 100 includes a main housing 108 having two clamshell housing halves 110, and a transmission housing 112 affixed to the main housing 108. The hydraulic torque impact mechanism 106 is supported within the transmission housing 112. A similar hydraulic torque impact mechanism is described and illustrated in U.S. Provisional Patent Application No. 62/379,393, filed Aug. 25, 2016, entitled “IMPACT TOOL”, and in corresponding U.S. patent application Ser. No. 16/309,625, filed Dec. 13, 2018, entitled “IMPACT TOOL”. The entire contents of these applications is hereby incorporated by reference. The planetary gear assembly 102 is positioned between the electric motor 104 (e.g., a brushless direct current motor) and the impact mechanism 106.

The impact driver 100 includes a battery mount portion 114 for removably coupling a battery pack (not shown). The battery pack may include any of a number of different nominal voltages (e.g., 12V, 18V, etc.), and may be configured having any of a number of different chemistries (e.g., lithium-ion, nickel-cadmium, etc.). In alternative embodiments (not shown), the motor 104 may be powered by a remote power source (e.g., a household electrical outlet) through a power cord.

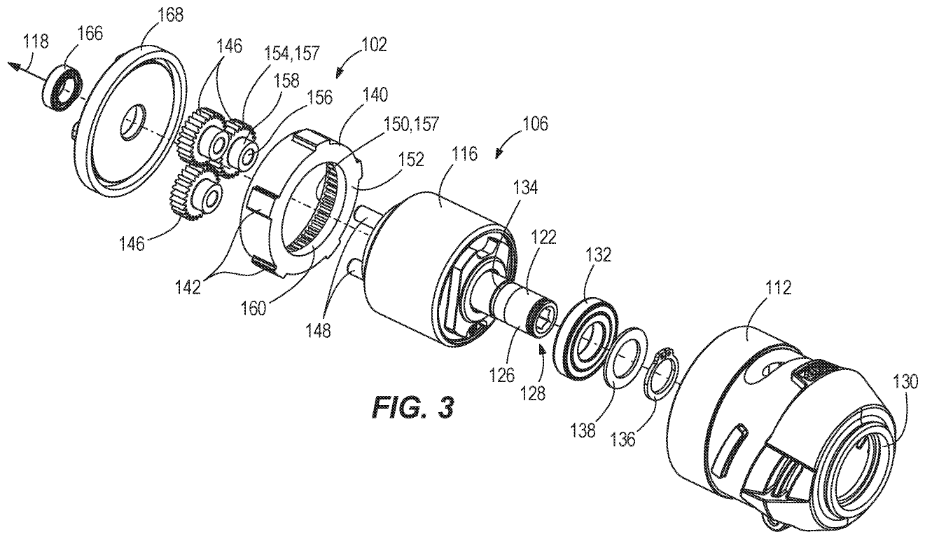

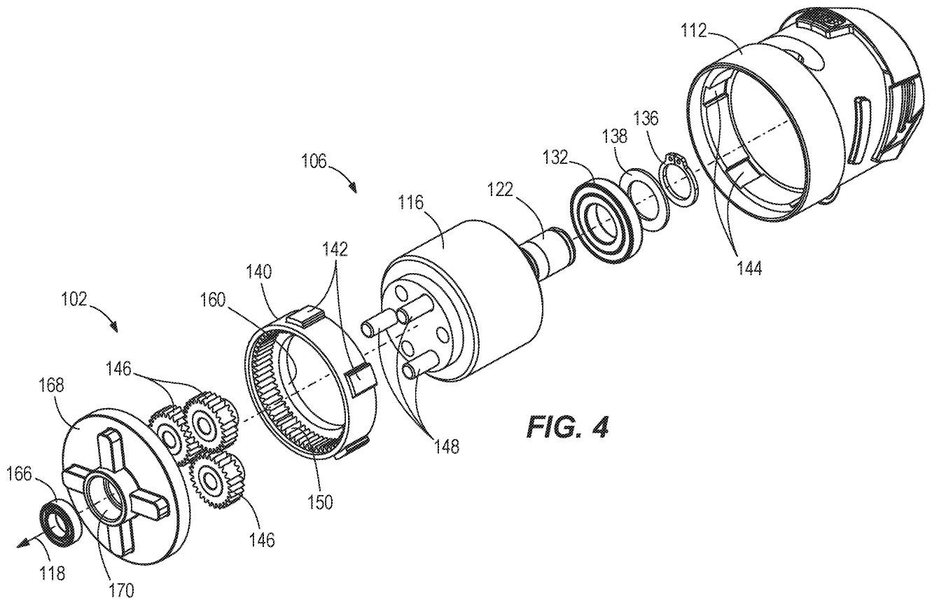

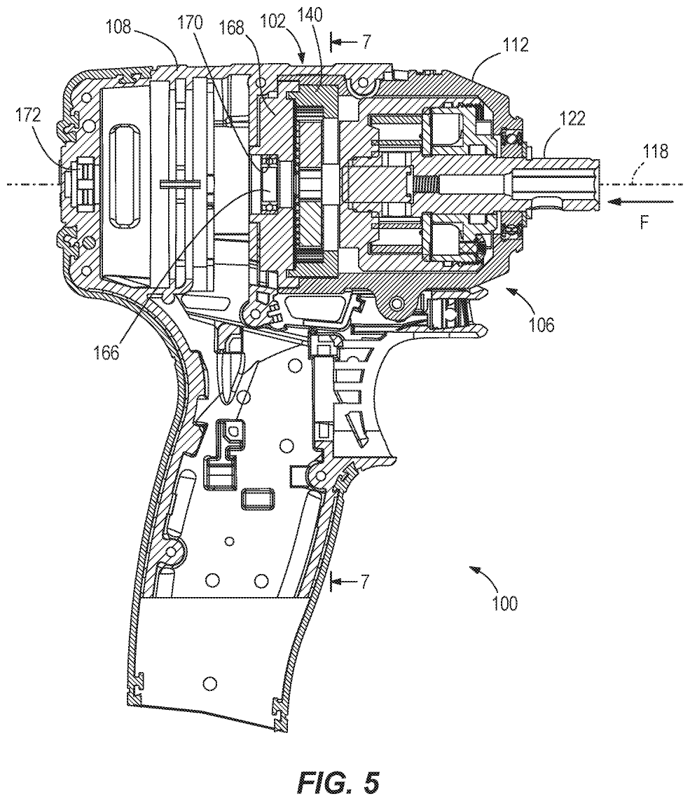

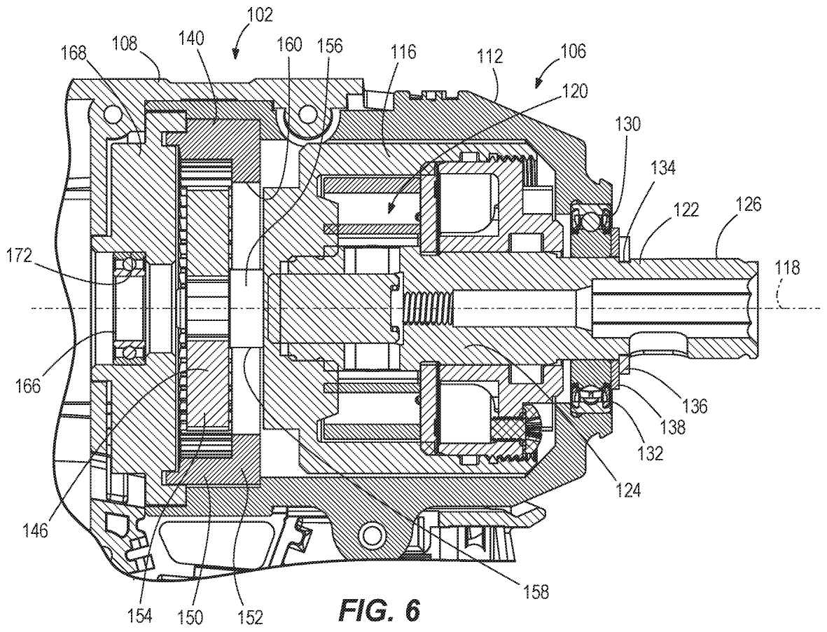

With reference to FIGS. 3 and 4, the impact mechanism 106 includes a drum 116 coupled for co-rotation with an output of the gear assembly 102 and arranged to rotate within the transmission housing 112. Accordingly, the drum 116 is rotatable about a longitudinal axis 118 (FIG. 3) coaxial with the output of the gear assembly 102. The drum 116 defines a cavity 120 (FIG. 5), and the impact mechanism 106 further includes an output shaft 122, a rear portion 124 (FIG. 6) of which is disposed within the cavity 120. A front portion 126 of the output shaft 122 extends from the transmission housing 112 and includes a hexagonal receptacle 128 (FIG. 3) therein for receipt of a tool bit. In operation, the drum 116 receives a continuous torque input from the motor 104, and the impact mechanism 106 converts the continuous torque input from the motor 104 to discrete torque impacts imparted on the output shaft 122.

With reference to FIG. 6, the transmission housing 112 includes an output shaft bearing pocket 130 that opens at the front of the transmission housing 112. The output shaft bearing pocket 130 receives an output shaft bearing 132 (e.g., by interference fit) that rotatably supports the output shaft 122. The output shaft 122 includes a circumferential groove 134, and a clip 136 (e.g., a C-clip) is axially affixed to the output shaft 122 within the groove 134. A washer 138 is supported about the output shaft 122 and sandwiched between the output shaft bearing 132 and the clip 136. The washer 138 radially overlaps both the output shaft bearing 132 and the clip 136. During operation of the impact driver 100, a reaction force F (FIG. 5) may be imparted on the output shaft 122 during a fastener driver operation. Such a reaction force F is transmitted from the output shaft 122 through the clip 136, the washer 138, the output shaft bearing 132, the transmission housing 112, and the main housing 108, and finally to a user's hand.

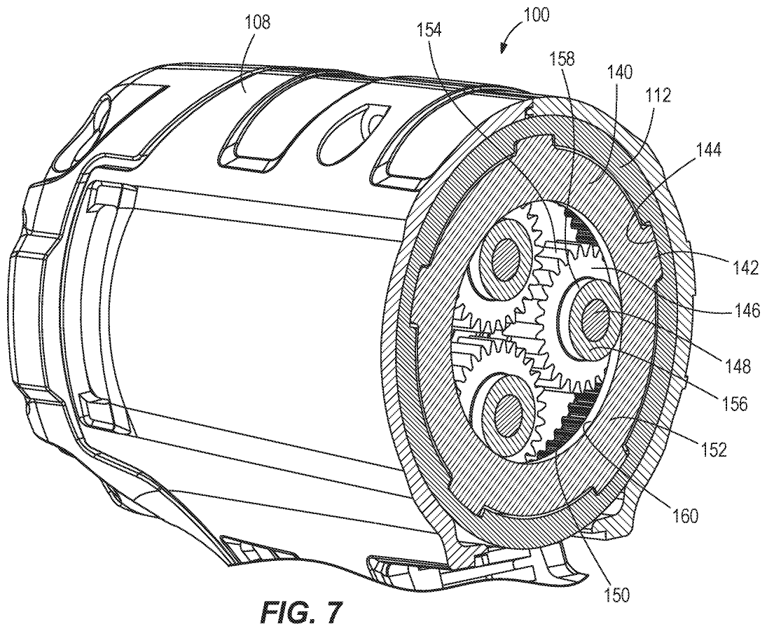

With reference to FIGS. 3, 4, and 7, the planetary gear assembly 102 includes a ring gear 140 received within the transmission housing 112. The ring gear 140 includes radial projections 142 that engage radial recesses 144 formed in the transmission housing 112 to rotationally fix the ring gear 140 relative to the transmission housing 112 (FIG. 7). The gear assembly 102 also includes planet gears 146 that mesh with the ring gear 140. The planet gears 146 are rotatably supported by cantilevered pins 148 extending from the drum 116, so that the drum 116 functions as a carrier supporting the planet gears 146.

As shown in FIG. 3, the ring gear 140 is divided into a ring gear portion 150 and a ring bearing portion 152. In the illustrated embodiment, the ring bearing portion 152 extends radially inward from the ring gear portion 150. Each planet gear 146 includes a planet gear portion 154 that meshes with the ring gear portion 150 of the ring gear 140, and a planet bearing portion 156 that engages the ring bearing portion 152 of the ring gear 140. The ring gear portion 150 and the planet gear portions 154 each include a plurality of teeth 157. The planet bearing portions 156 are cylindrically-shaped and include a cylindrical outer bearing surface 158 that is configured to roll along a cylindrical interior bearing surface 160 of the ring bearing portion 152. Because the ring bearing portion 152 is part of the ring gear 140, the cylindrical interior bearing surface 160 is integrally formed with the ring gear 140 as a single piece. And, because the planet gears 146 are carried by the pins 148 of the drum 116, the planet bearing portions 156 of each planet gear 146 radially support the drum 116 relative to the ring gear 140 and the transmission housing 112. That is, as the drum 116 rotates about the longitudinal axis 118, the cylindrical outer bearing surface 158 of each planet bearing portion 156 contacts and rolls along the cylindrical interior bearing surface 160 of the ring gear 140 to radially support and maintain the drum 116 coaxial with the longitudinal axis 118. In other embodiments, the cylindrical interior bearing surface may be separate from the ring gear 140. And, the ring gear 140 may not include a ring bearing portion. For example, in some embodiments, the cylindrical interior bearing surface can be defined by a separate component (e.g., a washer-shaped bracket) of the gear assembly 102. In other embodiments, the cylindrical interior bearing surface can be defined by an interior portion of the transmission housing 112.

With reference to FIG. 2, the motor 104 includes a motor shaft 162 that is rotatably supported within the main housing 108. The motor shaft 162 includes an output gear or pinion 164 that meshes with the planet gears 146. When powered, the motor 104 supplies torque to the motor shaft 162 to rotate the motor shaft 162 about the longitudinal axis 118.

With reference to FIG. 5, the motor shaft 162 (FIG. 2) is supported at each axial end by a front motor bearing 166 and a rear motor bearing (not shown), respectively. The impact driver 100 includes a bearing support 168 that defines a front motor bearing pocket 170 for receiving the front motor bearing 166 (e.g., by interference fit), and the main housing 108 defines a rear motor bearing pocket 172 for receiving the rear motor bearing (e.g., by interference fit). In the illustrated embodiment, the bearing support 168 is formed separately from the ring gear 140 and is supported by the transmission housing 112. In other embodiments (not shown), the bearing support 168 may be formed integrally with the ring gear 140 as a single part.

In operation, upon activation of the impact driver 100 (e.g., by depressing a trigger), the battery pack supplies power to the motor 104, causing the motor shaft 162 to rotate about the longitudinal axis 118. The pinion 164 rotates with the motor shaft 162 and supplies torque to the planet gears 146, causing the planet gears 146 to rotate about the respective pins 148. As the planet gears 146 rotate about the pins 148, the planet gears 146 also orbit about the longitudinal axis 118 due to the meshed engagement between the planet gear portions 154 and the ring gear portion 150. The orbital motion of the planet gears 146 thus rotates the drum 116 about the longitudinal axis 118. As the planet gears 146 rotate and orbit in the manner described above, the cylindrical outer bearing surface 158 of each planet bearing portion 156 rolls along the cylindrical interior bearing surface 160 of the ring bearing portion 152 (without sliding) to provide radial support to the drum 116. Alternatively, the planet bearing portion 156 may be a separate component from the planet gear 146 and rotatably coupled to the planet gear 146, such that the planet bearing portion 156 may rotate relative to the planet gear 146. This may prevent sliding contact between the planet bearing portion 156 and the ring bearing portion 152 if the outer diameter of the ring bearing portion 152 is not exactly equal to the operating pitch diameter of the meshed ring gear 140 and the planet gears 146. In such an embodiment, for example, the planet bearing portions 156 of the planet gears 146 may be configured as cylindrical bushings supported upon the respective pins 148. As the drum 116 rotates, torque is transmitted from the drum 116 to the output shaft 122 via operation of the hydraulic torque impact mechanism 106.

Various features of the disclosure are set forth in the following claims.

What is claimed is:

1. A power tool comprising:
a housing;
a motor positioned within the housing;
an output mechanism rotatably supported within the housing and configured to rotate about a longitudinal axis; and
a gear assembly positioned within the housing and coupled between the motor and the output mechanism to transfer torque generated by the motor to the output mechanism, the gear assembly including
a ring gear,
a cylindrical interior bearing surface adjacent the ring gear, and
a planet gear including a planet gear portion and a planet bearing portion that defines a cylindrical outer bearing surface;
wherein the planet gear portion is configured to mesh with the ring gear to rotate the output mechanism about the longitudinal axis, and wherein the cylindrical outer bearing surface is configured to roll along the cylindrical interior bearing surface to radially support the output mechanism for rotation about the longitudinal axis.

2. The power tool of claim 1, wherein the output mechanism includes a drum rotatable about the longitudinal axis.

3. The power tool of claim 2, wherein the drum includes a cantilevered pin that rotatably supports the planet gear.

4. The power tool of claim 2, wherein the planet gear radially supports the drum relative to the ring gear.

5. The power tool of claim 1, wherein the ring gear includes a radial projection that engages a radial recess formed in the housing.

6. The power tool of claim 1, wherein the cylindrical interior bearing surface is integrally formed with the ring gear as a single piece.

7. The power tool of claim 1, wherein the planet gear is carried by the output mechanism.

8. A power tool comprising:
a housing;
a motor positioned within the housing;
an output mechanism rotatably supported within the housing and configured to rotate about a longitudinal axis; and
a gear assembly positioned within the housing and coupled between the motor and the output mechanism to transfer torque generated by the motor to the output mechanism, the gear assembly including
a ring gear including a ring gear portion and a ring bearing portion that defines a cylindrical interior bearing surface, and
a planet gear carried by the output mechanism, the planet gear including a planet gear portion and a planet bearing portion that defines a cylindrical outer bearing surface;
wherein the planet gear portion is configured to mesh with the ring gear portion to rotate the output mechanism about the longitudinal axis, and wherein the cylindrical outer bearing surface is configured to roll along the cylindrical interior bearing surface to radially support the output mechanism for rotation about the longitudinal axis.

9. The power tool of claim 8, wherein the output mechanism includes a drum rotatable about the longitudinal axis.

10. The power tool of claim 9, wherein the drum includes a cantilevered pin that rotatably supports the planet gear.

11. The power tool of claim 9, wherein the planet bearing portion maintains the drum coaxial with the longitudinal axis.

12. The power tool of claim 8, wherein the motor includes a motor shaft having an output gear that meshes with the planet gear.

13. The power tool of claim 8, wherein the ring gear includes a radial projection that engages a radial recess formed in the housing.

14. The power tool of claim 8, wherein the planet gear is a first planet gear, and the gear assembly includes a second planet gear carried by the output mechanism.

15. An impact driver comprising:
a main housing;
a transmission housing coupled to the main housing;
a motor positioned within the main housing, the motor including a pinion;
a torque impact mechanism rotatably supported within the transmission housing and configured to rotate about a longitudinal axis, the torque impact mechanism including an output shaft and a drum configured to receive a continuous torque input from the motor; and
a gear assembly coupled between the motor and the drum and configured to transmit the continuous torque input from the motor to the drum, the gear assembly including
a ring gear,
a plurality of planet gears rotatably supported by the drum and meshed with the ring gear, and
a cylindrical interior bearing surface adjacent the ring gear;
wherein each planet gear includes a planet gear portion having a plurality of teeth meshed with corresponding teeth on the ring gear, and a cylindrical planet bearing portion extending from the planet gear portion and configured to roll along the cylindrical interior bearing surface to radially support the drum.

16. The impact driver of claim 15, wherein the drum includes a plurality of cantilevered pins that rotatably support the respective planet gears.

17. The impact driver of claim 15, wherein the planet bearing portion of each planet gear maintains the drum coaxial with the longitudinal axis.

18. The impact driver of claim 15, wherein the planet gear radially supports the drum relative to the ring gear.

19. The impact driver of claim 15, wherein the ring gear includes a radial projection that engages a radial recess formed in the transmission housing.

20. The impact driver of claim 15, wherein the motor includes a motor shaft having an output gear that meshes with each planet gear.
